(19) United States
(12) Patent Application Publication
(10) Pub. No.: US 2011/0299690 A1
(43) Pub. Date: Dec. 8, 2011

(54) METHOD AND APPARATUS FOR TRANSMITTING AUDIO DATA

(75) Inventor: Donghwan Lee, Gyeonggi-do (KR)

(73) Assignee: CORE LOGIC INC., Seoul (KR)

(21) Appl. No.: 13/202,690

(22) PCT Filed: Feb. 23, 2010
(86) PCT No.: PCT/KR10/01109

§ 371 Date: Aug. 22, 2011

(30) Foreign Application Priority Data
Feb. 23, 2009 (KR) 10-2009-0014629

(51) Int. Cl. H04R 5/00

(52) U.S. Cl. 381/17

(57) ABSTRACT

A method and apparatus for transmitting audio data is disclosed. In the method of sending audio data, audio data to be sent are divided into basic channel audio data and supplementary audio data for services of a high channel. When a left channel or a right channel is selected in response to a word selection signal in accordance with the standards of a serial bus, the basic channel audio data corresponding to a selected channel are sent, and at least one of the supplementary audio data is sent during the remaining time until another channel is selected in response to the word selection signal. Accordingly, audio data of a high channel, such as a 5.1 channel, can be sent without a design change using a serial bus for supporting a 2 channel, such as an I2S bus.

### TECHNICAL FIELD

The present invention relates to a method and apparatus for transmitting audio data, and more particularly, to technology for transmitting audio data, which is capable of transmitting the audio data of a high channel, such as a 5.1 channel, without a design change using a serial bus for supporting a 2 channel, such as an I2S bus.

### BACKGROUND ART

In general, I2S (Inter-IC Sound) refers to serial bus interface standards used to transmit and receive audio data between processors. I2S is used to process audio data separately from a clock signal. The I2S bus does not generate time-related errors, causing jitter, through such separate processing of the audio data and the clock signal, and so does not require an additional construction for preventing jitter. Because of such an advantage, the I2S bus is being widely used for a variety of devices for processing audio data, such as CD players, DVD players, MP3 players, mobile communication terminals, digital TV, and audio systems.

Typically, the I2S bus supports the transmission and reception of audio data through the 2 channel. To this end, the I2S bus includes a total of three serial bus lines; a LR clock line for transmitting LR selection signals, a bit clock line for transmitting bit clocks, and a data line for transmitting audio data.

To provide higher quality of services, a recent digital audio system provides digital surround play environments of a multi-channel as well as the existing 2 channel play environment. However, the I2S bus is problematic in that it may not be used to transmit audio data through a high channel, such as a 5.1 channel, because it supports only the transmission of audio data through a 2 channel. Accordingly, there is an urgent need for technology which is capable of transmitting audio data through a multi-channel, such as a 5.1 channel, using I2S.

### DISCLOSURE

### Technical Problem

Accordingly, it is an object of the present invention to provide a method and apparatus for transmitting audio data, which is capable of increasing the compatibility of I2S by allowing audio data to be transmitted through a high channel, such as a 5.1 channel, using serial bus standards (for example, I2S) for transmitting audio data.

### Technical Solution

To achieve the above object, an aspect of the present invention provides a method of sending audio data. The method of sending audio data includes dividing audio data to be sent into basic channel audio data and supplementary audio data for services of a high channel; generating a word selection signal according to standards of the serial bus; when a left channel or a right channel is selected in response to the word selection signal, sending the basic channel audio data corresponding to the selected channel; and after sending the basic channel audio data, sending at least one of the supplementary audio data during a remaining time until another channel is selected in response to the word selection signal.

The serial bus may be an I2S (Inter IC-Sound) bus. The basic channel audio data may be 2 channel audio data. The basic channel audio data may comprise right channel audio data and left channel audio data.

The high channel may be a 5.1 channel. In this case, the supplementary audio data may comprise at least one of right channel surround data, left channel surround data, center data, and low frequency effects data.

In the case in which the left channel is selected in response to the word selection signal, sending at least one of the supplementary audio data may comprise sending at least one of the supplementary audio data during a remaining time until the right channel is selected in response to the word selection signal, after sending the basic channel audio data. On the other hand, in the case in which the right channel is selected in response to the word selection signal, sending at least one of the supplementary audio data may comprise sending at least one of the supplementary audio data during a remaining time until the left channel is selected in response to the word selection signal, after sending the basic channel audio data.

Meanwhile, the method may further comprise packetizing each of the basic channel audio data and the supplementary audio data in accordance with the standards of the serial bus. The method may further comprise receiving the audio data from external source and determining whether the received audio data include the supplementary audio data for the services of the high channel.

To achieve the above object, another aspect of the present invention provides a method of sending data using a serial bus. The method may comprise dividing audio data to be sent into basic channel audio data and supplementary audio data for services of a high channel; configuring an audio data packet, including the basic channel audio data, in accordance with standards of the serial bus; inserting the supplementary audio data into an empty region of the audio data packet which is left after inserting the basic channel audio data; and sending an audio data packet, including the basic channel audio data and the supplementary audio data.

Inserting the supplementary audio data into an empty region of the audio data packet is performed with consideration taken of a length of a packet which can be sent through each channel in accordance with the standards of the serial bus.

To achieve the above object, yet another aspect of the present invention provides an audio data transmission apparatus for sending audio data through a serial bus. The audio data transmission apparatus comprises an audio data processor for dividing audio data to be sent into basic channel audio data and supplementary audio data of services of a high channel and a serial bus transmission controller for generating a word selection signal in accordance with standards of the serial bus, sending the basic channel audio data corresponding to a selected channel when a left channel or a right channel is selected in response to the word selection signal, and then sending at least one of the supplementary audio data during a remaining time until another channel is selected in response to the word selection signal.

The audio data transmission apparatus may further comprise an audio data reception unit for receiving the audio data from external source. The audio data may be pulse code modulation (PCM) data. The serial bus may be an I2S bus.

The audio data processor preferably may packetize the basic channel audio data and the supplementary audio data in accordance with the standards of the serial bus.

The basic channel audio data may be 2 channel audio data. The basic channel audio data may comprise, for example, right channel audio data and left channel audio data.

Meanwhile, the high channel may be a 5.1 channel. The supplementary audio data may comprise at least one of right channel surround data, left channel surround data, center data, and low frequency effects data.

When the left channel is selected in response to the word selection signal, the serial bus transmission controller may send the basic channel audio data and then send at least one of the supplementary audio data during a remaining time until the right channel is selected in response to the word selection signal.

On the other hand, when the right channel is selected in response to the word selection signal, the serial bus transmission controller may send the basic channel audio data and then send at least one of the supplementary audio data during a remaining time until the left channel is selected in response to the word selection signal.

### Advantageous Effects

As described above, according to the present invention, audio data of a high channel, such as a 5.1 channel, can be transmitted using a serial bus for supporting a 2 channel, such as I2S, without a design change. Accordingly, there is an advantage in that the compatibility of the serial bus can be increased.

### DESCRIPTION OF DRAWINGS

FIG. 1 is a timing diagram showing the waveforms of signals transmitted over an I2S bus;

FIG. 2 is a block diagram of a transmission system for realizing a method of sending audio data according to an exemplary embodiment of the present invention;

FIG. 3 is a block diagram showing the construction of an audio data transmission apparatus shown in FIG. 2;

FIG. 4 is a block diagram showing the construction of an audio data reception apparatus shown in FIG. 2;

FIG. 5 is a flowchart illustrating a method of sending audio data according to an exemplary embodiment of the present invention;

FIG. 6 is a timing diagram showing a process of transmitting audio data according to an exemplary embodiment of the present invention; and

FIG. 7 is an exemplary flowchart illustrating a method of sending audio data according to another exemplary embodiment of the present invention.

### MODE FOR INVENTION

Some exemplary embodiments of the present invention will be described in detail below with reference to the accompanying drawings so that those skilled in the art can easily implement the present invention. In the exemplary embodiments of the present invention, specific technical terminologies are used for the clarity of the contents. It is to be understood, however, that the present invention is not limited to the specific terminologies and each specific terminology includes all technical synonyms operating in a similar way in order to accomplish similar objects.

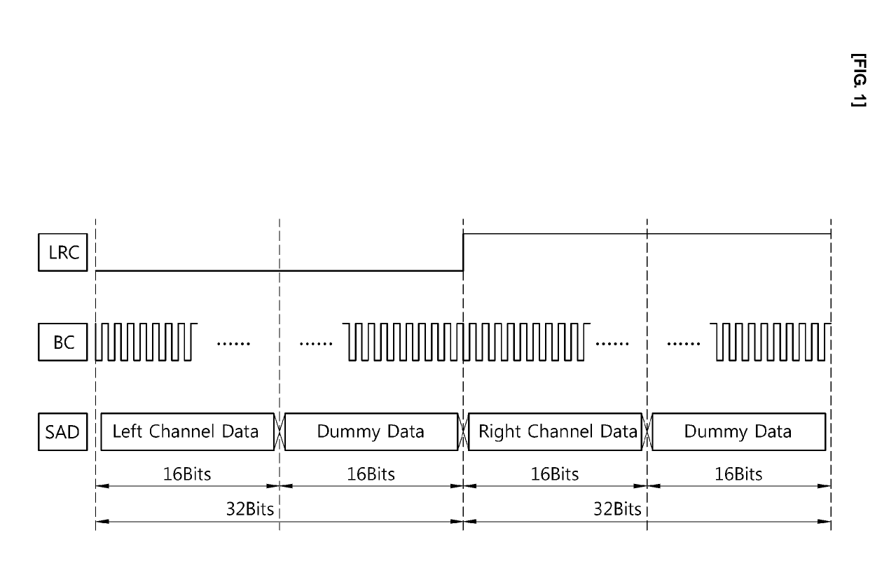

FIG. 1 is a timing diagram showing the waveforms of signals transmitted through an I2S (Inter IC Sound) bus.

Referring to FIG. 1, the I2S bus sends a LR clock LRC, a bit clock BC, and serial audio data SAD using three lines.

The LR clock LRC may refer to a word selection signal for distinguishing a left (L) channel or a right (R) channel from each other in a 2 channel audio signal. For example, as shown in FIG. 1, when the LR clock LRC is in a low level, the LR clock LRC may indicate an L channel signal. When the LR clock LRC is in a high level, the LR clock LRC may indicate an R channel signal. Meanwhile, when the LR clock LRC is in a high level, the LR clock LRC may indicate an L channel signal. When the LR clock LRC is in a low level, the LR clock LRC may indicate an R channel signal. The number of bits that can be transmitted per cycle of the LR clock LRC is typically 32 to 64 bits.

The bit clock BC is a signal necessary when audio data are sampled. The bit clock BC may also be used for synchronization between signals when audio data are transmitted and received. Upon synchronization, each of the signals can be synchronized with the rising edge or the falling edge of the bit clock BC. Here, whether the signal will be synchronized with the rising edge or the falling edge is optional.

The serial audio data SAD can include an audio data packet composed in a serial form. The serial audio data SAD can include an audio data packet having a maximum of 32 bits for each of an L channel and an R channel per cycle of an LR clock. However, when audio data of a 2 channel are transmitted, audio data inserted into each channel per cycle of an LR clock are only 8 bits to 24 bits. Accordingly, meaningless dummy data are inserted into the remaining regions.

For example, in the example shown in FIG. 1, the size of an audio data packet that can be inserted into each channel per cycle of the LR clock is 32 bits. However, the size of an audio data packet that is actually inserted into each channel per cycle of the LR clock is 16 bits. Accordingly, meaningless dummy data are inserted into the remaining 16-bit regions in order to set up synchronization.

Meanwhile, to provide higher quality of services, a recent digital audio system provides digital surround play environments of a multi-channel as well as the existing 2 channel play environment. However, as described above, the I2S bus may not be used to transmit audio data through a high channel (for example, a 5.1 channel) because it supports the transmission of audio data through a 2 channel. Accordingly, there is a need for technology which can transmit audio data through a multi-channel, such as a 0.1 channel, using a serial bus such as the I2S bus.

According to the following exemplary embodiments of the present invention, technology capable of transmitting audio data through a high channel using a serial bus, such as the I2S bus, is described.

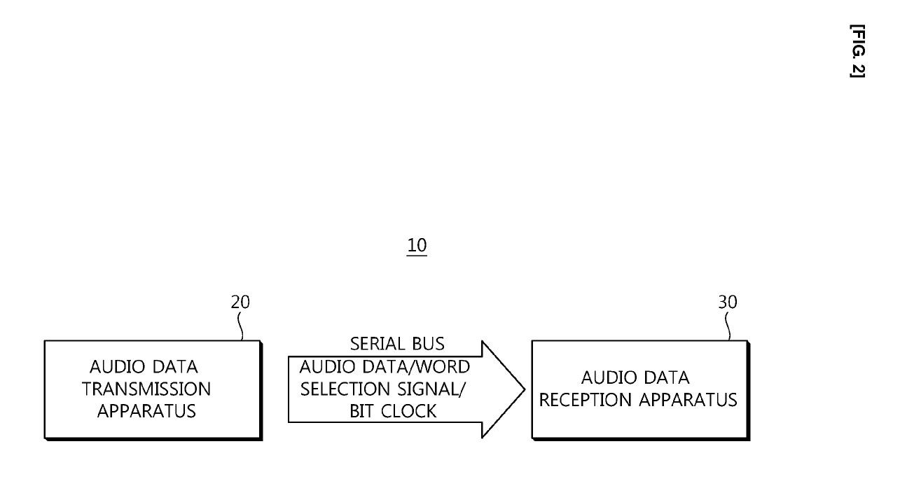

FIG. 2 is a block diagram of a transmission system for realizing a method of sending audio data according to an exemplary embodiment of the present invention.

Referring to FIG. 2, the transmission system 10 can include an audio data transmission apparatus 20 and an audio data reception apparatus 30.

The audio data transmission apparatus 20 can send audio data to the audio data reception apparatus 30 through a serial bus having specific standards. For example, the serial bus can be an I2S (Inter IC Sound) bus (i.e., serial bus interface standards for transmitting audio data).

The serial bus, such as the I2S bus, typically supports the transmission of 2 channel audio data, whereas the audio data transmission apparatus 20 according to an exemplary embodiment of the present invention can send audio data of a high channel (for example, a 5.1 channel) using a dummy data transmission region for each channel without changing the standards of the serial bus.

The transmission system 10 can be included in various audio data processing devices (for example, CD players, DVD players, MP3 players, audio/speaker systems, digital TV, and mobile communication terminals) in which audio data need to be transmitted and received between devices or processors.

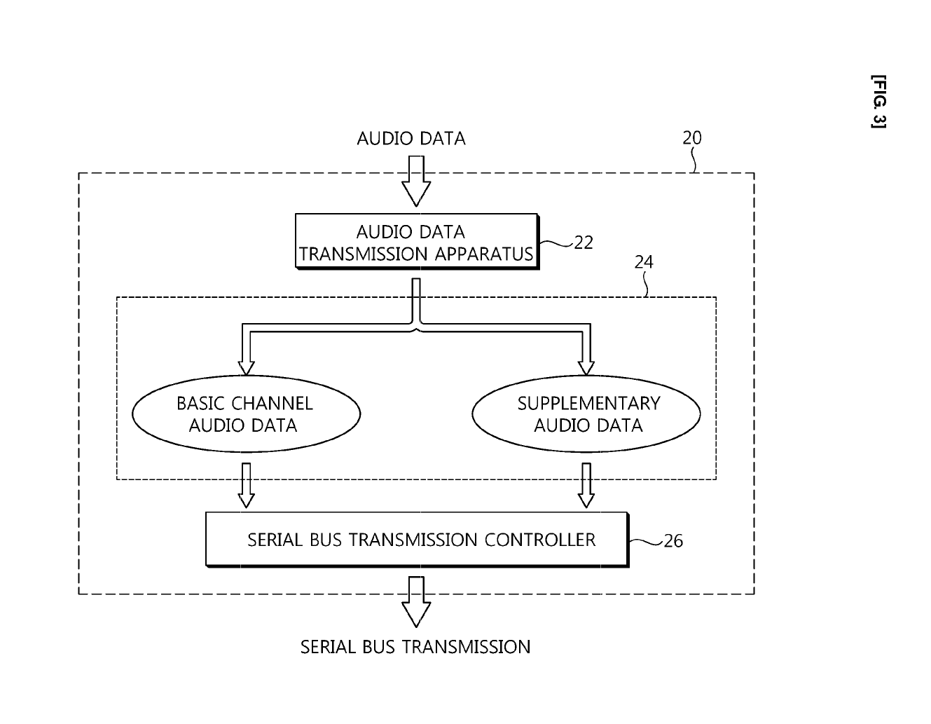

FIG. 3 is a block diagram showing the construction of the audio data transmission apparatus 20 shown in FIG. 2.

As shown in FIG. 3, the audio data transmission apparatus 20 can include an audio data reception unit 22, an audio data processor 24, and a serial bus transmission controller 26.

The audio data reception unit 22 functions to receive external audio data. The audio data can be, for example, pulse code modulation (PCM) data.

The audio data processor 24 can determine whether audio data capable of providing services of a high channel (for example, a 5.1 channel) exceeding a 2 channel exist in the audio data by analyzing the audio data received by the audio data reception unit 22. If, as a result of the determination, the audio data capable of providing services of a high channel are determined to be included, the audio data processor 24 can divide the corresponding audio data into basic channel audio data and supplementary audio data for providing services of a high channel and can packet the divided basic channel audio data and the divided supplementary audio data in a form complying with the standards of a serial bus.

Here, the basic channel audio data can refer to 2 channel audio data (for example, left channel audio data and right channel audio data). Further, the supplementary audio data can refer to audio data which are additionally necessary to play audio data of a high channel (for example, a 5.1 channel). For example, the supplementary audio data may include left surround data, right surround data, center data, and low frequency effects data in a 5.1 channel.

The serial bus transmission controller 26 generates signals (for example, a word selection signal and a bit clock) necessary to send data through the serial bus and transmits the packetized basic channel audio data and supplementary audio data in response to the word selection signal (for example, an LR clock in the I2S bus).

For example, the serial bus transmission controller 26 can generate a word selection signal and a bit clock according to the standards of a serial bus, transmit the basic channel audio data corresponding to a selected channel when an L channel or an R channel are selected in response to the word selection signal, and transmit at least one of the divided supplementary audio data instead of the basic dummy data using the remaining time until another channel is selected in response to the word selection signal.

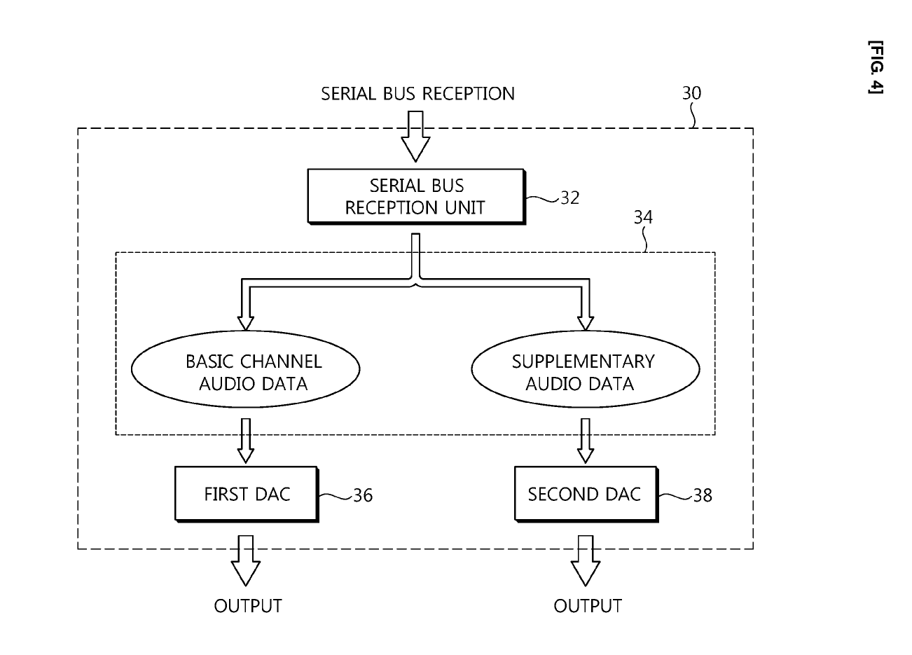

FIG. 4 is a block diagram showing the construction of the audio data reception apparatus 30 shown in FIG. 2.

As shown in FIG. 4, the audio data reception apparatus 30 can include a serial bus reception unit 32, an audio data extraction unit 34, a first digital to analog converter (DAC) 36, and a second DAC 38. The audio data reception apparatus 30 can be, for example, an audio codec.

The serial bus reception unit 32 functions to receive signals (for example, audio data, a bit clock, and a word selection signal) from the audio data transmission apparatus 20 and to store the received signals in a buffer. The audio data can include packetized basic channel audio data and packetized supplementary audio data.

The audio data extraction unit 34 extracts basic channel audio data and supplementary audio data from the audio data, stored in the serial bus reception unit 32, in response to the word selection signal and sends the extracted basic channel audio data and the extracted supplementary audio data to the first DAC 36 and the second DAC 38, respectively.

The first DAC 36 converts the basic channel audio data, received from the audio data extraction unit 34, into an analog signal and outputs the analog signal to a play apparatus for playing data through a basic channel. According to the same concept, the second DAC 38 converts the supplementary audio data, received from the audio data extraction unit 34, into an analog signal and outputs the analog signal to a play apparatus for playing data through a supplementary channel other than the basic channel.

The transmission system, including the audio data transmission apparatus for realizing a method of sending audio data according to the exemplary embodiment of the present invention, has been described above. The audio data transmission apparatus can send audio data for higher channel services using a serial bus (for example, the I2S bus) supporting a 2 channel. The method of sending audio data using the audio data transmission apparatus according to an exemplary embodiment of the present invention is described below.

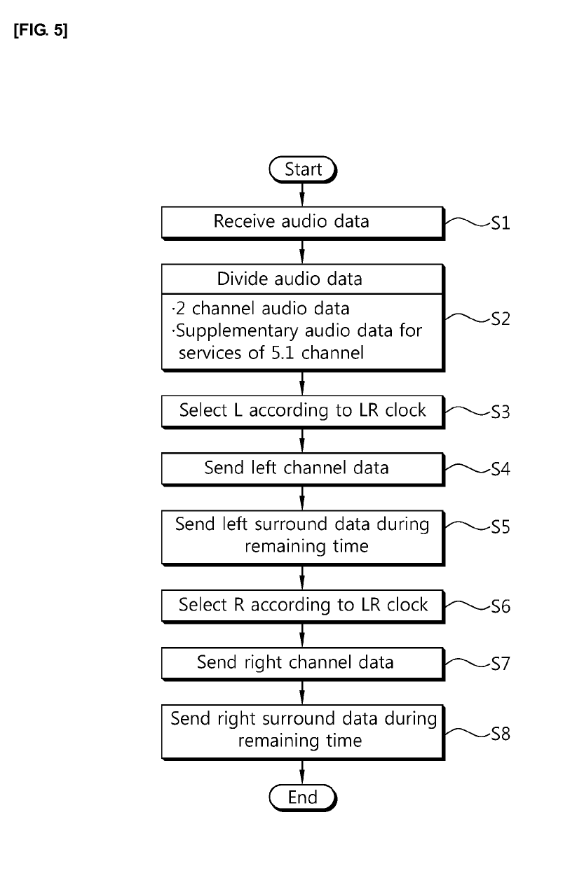

FIG. 5 is a flowchart illustrating the method of sending audio data according to the exemplary embodiment of the present invention. This figure illustrates a process of sending audio data through a 5.1 channel using the I2S bus supporting a 2 channel.

Referring to FIG. 5, first, the audio data transmission apparatus 20 receives audio data at step S1. The audio data preferably may be PCM data.

The audio data transmission apparatus determines whether audio data for providing 5.1 channel services are included in the received audio data by analyzing the received audio data. If, as a result of the determination, audio data for providing 5.1 channel services are determined to be included in the received audio data, the audio data transmission apparatus divides the corresponding audio data into 2 channel audio data and supplementary audio data for 5.1 channel services at step S2 and packetizes the divided 2 channel audio data and the divided supplementary audio data in accordance with the I2S bus standards.

The 2 channel audio data can include, for example, left channel audio data and right channel audio data. Further, the supplementary audio data can include audio data (for example, left surround data, right surround data, center data, and low frequency effects data) necessary to provide 5.1 channel services.

The audio data transmission apparatus can generate an LR clock (i.e., a word selection signal necessary to send data through a serial bus), a bit clock, etc. and send the packetized basic channel audio data and supplementary audio data in accordance with the LR clock at steps S3 to S8.

For example, assuming that an L channel has been selected in response to the LR clock (i.e., the word selection signal) at step S3, the audio data transmission apparatus can send left channel audio data (i.e., basic channel audio data corresponding to the L channel) using a serial audio data transmission line at step S4 and send the supplementary audio data (for example, left surround data and center data) during the remaining time until an R channel is selected in response to the LR clock at step S5.

Next, when the R channel is selected according to the shift of the LR clock to another level at step S6, the audio data transmission apparatus can send right channel audio data (i.e., basic channel audio data corresponding to the right channel) using a serial audio data transmission line at step S7 and send the supplementary audio data (for example, right surround data and low frequency effects data) during the remaining time until the L channel is selected in response to the LR clock at step S8.

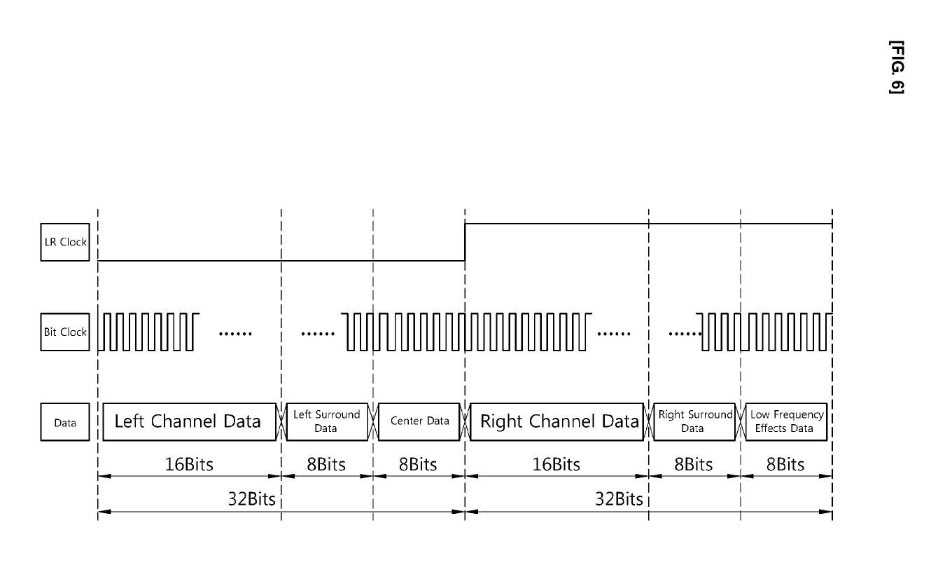

FIG. 6 is a timing diagram showing a process of transmitting audio data according to an exemplary embodiment of the present invention. It is assumed that the number of bits that can be transmitted per cycle of an LR clock is 64 bits and 32 bits can be transmitted through each channel. It is also assumed that when the LR clock (i.e., a word selection signal) is in a low level, an L channel is selected, and when the LR clock is in a high level, an R channel is selected. It is, however, to be noted that the above assumption is only illustrative and does not limit the spirit of the present invention.

As shown in FIG. 6, when the LR clock (i.e., a word selection signal) is in a low level indicative of the selection of the L channel, left channel audio data of 16 bits are transmitted, and left surround data of 8 bits and center data of 8 bits are then transmitted during the remaining time during which additional 16 bits can be transmitted.

When the LR clock shifts to a high level indicative of the selection of the R channel, right channel audio data of 16 bits are transmitted, and right surround data of 8 bits and low frequency effects data of 8 bits are then transmitted during the remaining time during which additional 16 bits can be transmitted.

The exemplary embodiments of the present invention have been described above. According to the disclosed technology, audio data of a high channel, such as a 5.1 channel, can be transmitted without changing bus standards using a serial bus supporting a 2 channel. Meanwhile, the example in which basic channel audio data and supplementary audio data are configured in the form of separate packets and then sent has been described. According to another exemplary embodiment of the present invention, an example in which basic channel audio data and supplementary audio data are configured in the form of one serial type data packet and then sent is described below.

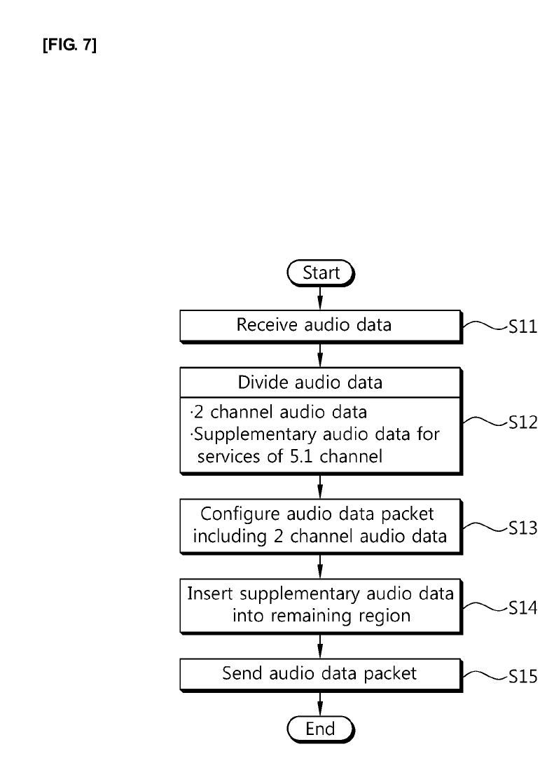

FIG. 7 is an exemplary flowchart illustrating a method of sending audio data according to another exemplary embodiment of the present invention. This figure illustrates a process of sending audio data through a 5.1 channel using the I2S bus supporting a 2 channel.

As shown in FIG. 7, first, the audio data transmission apparatus 20 receives audio data at step S11. The audio data preferably may be PCM data.

The audio data transmission apparatus determines whether audio data for providing 5.1 channel services are included in the received audio data by analyzing the received audio data. If, as a result of the determination, audio data for providing 5.1 channel services are determined to be included in the received audio data, the audio data transmission apparatus divides the corresponding audio data into 2 channel audio data and supplementary audio data for 5.1 channel services at step S12.

The audio data transmission apparatus configures an audio data packet of the I2S standards, including the divided 2 channel audio data at step S13. The audio data transmission inserts at least one supplementary audio data into an empty region (i.e., the remaining region) of the audio data packet, which is left after basic channel audio data are inserted into the audio data packet by taking the length of the audio data packet into consideration at step S14.

The audio data transmission apparatus sends the audio data packet, including the basic channel audio data and the supplementary audio data, to the audio data reception apparatus 30 in response to an LR clock (i.e., a word selection signal) at step S15.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of sending data using a serial bus, the method comprising:
dividing audio data to be sent into basic channel audio data and supplementary audio data for services of a high channel;
generating a word selection signal according to standards of the serial bus;
when a left channel or a right channel is selected in response to the word selection signal, sending the basic channel audio data corresponding to the selected channel; and
after sending the basic channel audio data, sending at least one of the supplementary audio data during a remaining time until another channel is selected in response to the word selection signal.

2. The method of claim 1, wherein the serial bus is an I2S (Inter IC-Sound) bus.

3. The method of claim 1, wherein the basic channel audio data are 2 channel audio data and comprise right channel audio data and left channel audio data.

4. The method of claim 3, wherein:
the high channel is a 5.1 channel, and
the supplementary audio data comprise at least one of right channel surround data, left channel surround data, center data, and low frequency effects data.

5. The method of claim 1, wherein in a case in which the left channel is selected in response to the word selection signal, sending at least one of the supplementary audio data comprises sending at least one of the supplementary audio data during a remaining time until the right channel is selected in response to the word selection signal, after sending the basic channel audio data.

6. The method of claim 1, wherein in a case in which the right channel is selected in response to the word selection signal, sending at least one of the supplementary audio data comprises sending at least one of the supplementary audio data during a remaining time until the left channel is selected in response to the word selection signal, after sending the basic channel audio data.

7. The method of claim 1, further comprising packetizing each of the basic channel audio data and the supplementary audio data in accordance with the standards of the serial bus.

8. The method of claim 1, further comprising:
receiving the audio data from external source; and
determining whether the received audio data include the supplementary audio data for the services of the high channel.

9. A method of sending data using a serial bus, the method comprising:
dividing audio data to be sent into basic channel audio data and supplementary audio data for services of a high channel;
configuring an audio data packet, including the basic channel audio data, in accordance with standards of the serial bus;
inserting the supplementary audio data into an empty region of the audio data packet which is left after inserting the basic channel audio data; and
sending an audio data packet, including the basic channel audio data and the supplementary audio data.

10. The method of claim 9, wherein inserting the supplementary audio data into an empty region of the audio data packet is performed with consideration taken of a length of a packet which can be sent through each channel in accordance with the standards of the serial bus.

11. An audio data transmission apparatus for sending audio data through a serial bus, the audio data transmission apparatus comprising:
an audio data processor for dividing audio data to be sent into basic channel audio data and supplementary audio data of services of a high channel; and
a serial bus transmission controller for generating a word selection signal in accordance with standards of the serial bus, sending the basic channel audio data corresponding to a selected channel when a left channel or a right channel is selected in response to the word selection signal, and then sending at least one of the supplementary audio data during a remaining time until another channel is selected in response to the word selection signal.

12. The audio data transmission apparatus of claim 11, further comprising an audio data reception unit for receiving the audio data from external source, wherein the audio data are pulse code modulation (PCM) data.

13. The audio data transmission apparatus of claim 11, wherein the serial bus is an I2S bus.

14. The audio data transmission apparatus of claim 11, wherein the audio data processor packetizes the basic channel audio data and the supplementary audio data in accordance with the standards of the serial bus.

15. The audio data transmission apparatus of claim 11, wherein the basic channel audio data are 2 channel audio data and comprise right channel audio data and left channel audio data.

16. The audio data transmission apparatus of claim 11, wherein:
the high channel is a 5.1 channel, and
the supplementary audio data comprise at least one of right channel surround data, left channel surround data, center data, and low frequency effects data.

17. The audio data transmission apparatus of claim 11, wherein:
when the left channel is selected in response to the word selection signal, the serial bus transmission controller sends the basic channel audio data and then sends at least one of the supplementary audio data during a remaining time until the right channel is selected in response to the word selection signal, and
when the right channel is selected in response to the word selection signal, the serial bus transmission controller sends the basic channel audio data and then sends at least one of the supplementary audio data during a remaining time until the left channel is selected in response to the word selection signal.
